(19) United States
(12) Patent Application Publication
(10) Pub. No.: US 2026/0246382 A1
(43) Pub. Date: Aug. 20, 2026

(54) Frequency Synchronization Apparatus and Control Method

(71) Applicant: Xi An M3 Semiconductor Corporation, Xi'an (CN)

(72) Inventors: Yanli Zhu, Xi 'an (CN); Xiaoyu Xi, Dallas, TX (US); Bo Yang, Allen, TX (US)

(21) Appl. No.: 19/061,333

(22) Filed: Feb. 24, 2025

(30) Foreign Application Priority Data
Feb. 19, 2025 (CN) 2025101858662

(51) Int. Cl. H02M 3/156; H03L 7/091

(52) U.S. Cl. CPC H02M 3/156; H03L 7/091

(57) ABSTRACT

An apparatus includes an on-timer configured to produce a reset signal for determining a turn-off time instant of a high-side switch of a power converter, wherein the on-timer comprises a ramp generator, a feedback control circuit configured to produce a set signal for determining a turn-on time instant of the high-side switch of the power converter, and a phase-locked loop circuit configured to receive a clock signal and adjust a current of the ramp generator only once over a plurality of predetermined switching periods to synchronize a pulse width modulation (PWM) signal of the power converter with the clock signal.

### CROSS-REFERENCE TO RELATED APPLICATIONS

This patent application claims priority to Chinese Patent Application No. CN 2025101858662, filed on Feb. 19, 2025, and entitled “Frequency Synchronization Apparatus and Control Method,” which is hereby incorporated by reference herein as if reproduced in its entirety.

### TECHNICAL FIELD

The present invention relates to a frequency synchronization apparatus, and, in particular embodiments, to a frequency synchronization apparatus for a constant on-time power converter.

### BACKGROUND

As technologies further advance, a variety of computing and mobile devices such as laptops, mobile phones, tablet PCs, digital cameras, MP3 players and/or the like, have become popular. With fast advance in communication, computing and mobile devices, more and more systems need low voltage and high current power supplies with fast transient response. At the same time, low quiescent current is also important for those systems as many of them are powered by batteries. Among various power supply control mechanisms, constant on-time control offers a rapid transient response and low quiescent current for switching mode power converters.

A constant on-time power converter operates by controlling the duration of the on-time of the main switch, with the off-time being variable and determined by the load and input voltage conditions. The primary advantage of constant on-time power converters is their simplicity and inherent ability to respond quickly to changes in load and input conditions, making them well-suited for applications where rapid regulation is required.

In many applications, such as servers, computing systems, and power management modules, multiphase operation is commonly employed to meet the high current demands of modern electronics. Multiphase power converters operate by interleaving multiple phases of power converters to share the load current, reduce output voltage ripple, and improve overall system efficiency. To achieve these benefits, precise frequency synchronization across multiple phases is essential. Frequency synchronization ensures that each phase operates at a consistent switching frequency and maintains proper interleaving, thereby minimizing electromagnetic interference (EMI), reducing output noise, and achieving optimal power delivery.

While frequency synchronization is critical for multiphase systems, achieving it in constant on-time power converters presents significant challenges. Unlike fixed-frequency converters, constant on-time power converters operate with a variable switching frequency that depends on the input voltage, output voltage, and load conditions. This inherent variability in frequency makes it difficult to implement frequency synchronization control mechanisms. Additionally, conventional constant on-time control architectures lack a direct control mechanism to regulate or align switching frequencies, further complicating their use in multiphase configurations.

Consequently, there is a need for innovative techniques to enable frequency synchronization in constant on-time power converters. Such advancements would address the challenges associated with multiphase operation, ensuring stable, efficient, and low-noise performance in applications requiring high power delivery and stringent regulation.

### SUMMARY

Technical advantages are generally achieved, by embodiments of this disclosure which describe a frequency synchronization apparatus for a constant on-time power converter.

In accordance with an embodiment, an apparatus comprises an on-timer configured to produce a reset signal for determining a turn-off time instant of a high-side switch of a power converter, wherein the on-timer comprises a ramp generator, a feedback control circuit configured to produce a set signal for determining a turn-on time instant of the high-side switch of the power converter, and a phase-locked loop circuit configured to receive a clock signal and adjust a current of the ramp generator only once over a plurality of predetermined switching periods to synchronize a pulse width modulation (PWM) signal of the power converter with the clock signal.

In accordance with another embodiment, a method comprises generating a set signal for determining a turn-on time instant of a high-side switch of a power converter, generating, by an on-timer, a reset signal for determining a turn-off time instant of the high-side switch of the power converter, and based upon a received clock signal, adjusting, by a phase-locked loop circuit, a current of a ramp generator of the on-timer only once over a plurality of predetermined switching periods to synchronize a PWM signal of the power converter with the clock signal.

In accordance with yet another embodiment, a power converter comprises a power stage comprising a high-side switch and a low-side switch connected in series between an input voltage bus and ground, an inductor connected between a common node of the high-side switch and the low-side switch, and an output terminal of the power converter, and a control apparatus comprising an on-timer configured to produce a reset signal for determining a turn-off time instant of the high-side switch of a power converter, wherein the on-timer comprises a ramp generator, a feedback control circuit configured to produce a set signal for determining a turn-on time instant of the high-side switch of the power converter, and a phase-locked loop circuit configured to receive a clock signal and adjust a current of the ramp generator only once over a plurality of predetermined switching periods to synchronize a PWM signal of the power converter with the clock signal.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a constant on-time power converter in accordance with various embodiments of the present disclosure;

FIG. 2 illustrates a timing diagram of various signals associated with the constant on-time power converter shown in FIG. 1 in accordance with various embodiments of the present disclosure;

FIG. 3 illustrates a schematic diagram of the PWM generator shown in FIG. 1 in accordance with various embodiments of the present disclosure;

FIG. 4 illustrates a timing diagram of various signals associated with a first control implementation of the phase-locked loop circuit shown in FIG. 3 in accordance with various embodiments of the present disclosure;

FIG. 5 illustrates a small signal model of the phase-locked loop circuit shown in FIG. 3 in accordance with various embodiments of the present disclosure;

FIG. 6 illustrates a Bode plot of the phase-locked loop circuit shown in FIG. 3 in accordance with various embodiments of the present disclosure;

FIG. 7 illustrates a timing diagram of various signals associated with a second control implementation of the phase-locked loop circuit shown in FIG. 3 in accordance with various embodiments of the present disclosure; and

FIG. 8 illustrates a flow chart of a method for controlling the constant on-time power converter shown in FIG. 1 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to preferred embodiments in a specific context, namely a frequency synchronization apparatus for a constant on-time power converter. The invention may also be applied, however, to a variety of power converters. Hereinafter, various embodiments will be explained in detail with reference to the accompanying drawings.

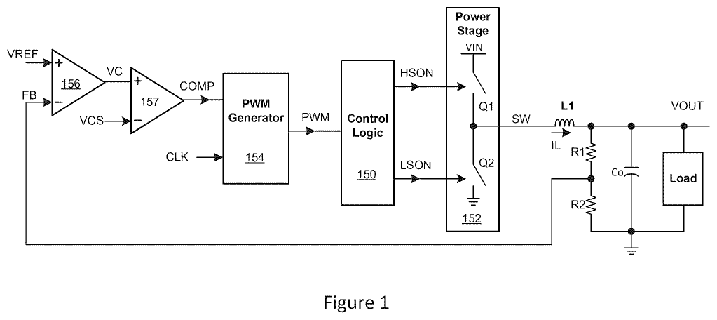

FIG. 1 illustrates a constant on-time power converter in accordance with various embodiments of the present disclosure. The constant on-time power converter comprises a high-side switch Q1, a low-side switch Q2, an inductor L1 and an output capacitor Co. As shown in FIG. 1, switches Q1 and Q2 are connected in series between an input voltage bus VIN and ground. Switches Q1 and Q2 form a power stage 152. The inductor L1 is connected between a common node of Q1 and Q2, and the output terminal VOUT of the constant on-time power converter. The common node of Q1 and Q2 is denoted as SW. The output capacitor Co is connected between VOUT and ground. A load is coupled between VOUT and ground.

The switches (e.g., Q1) shown in FIG. 1 may be implemented as n-type metal oxide semiconductor (NMOS) transistors. Alternatively, the switches may be implemented as other suitable controllable devices such as metal oxide semiconductor field effect transistor (MOSFET) devices, bipolar junction transistor (BJT) devices, super junction transistor (SJT) devices, insulated gate bipolar transistor (IGBT) devices, gallium nitride (GaN) based power devices, any combinations thereof and the like.

The control circuit of the constant on-time power converter comprises an error amplifier 156, a comparator 157, a pulse width modulation (PWM) generator 154, a control logic block 150 and a voltage divider formed by a first resistor R1 and a second resistor R2 connected in series between VOUT and ground.

As shown in FIG. 1, the inverting input of the error amplifier 156 is employed to detect the output voltage VOUT through the voltage divider formed by resistors R1 and R2. The signal fed into the inverting input of the error amplifier 156 is denoted as a feedback signal FB. The non-inverting input of the error amplifier 156 is connected to a predetermined reference VREF. The output of the error amplifier 156 is fed into a non-inverting input of the comparator 157. The output signal of the error amplifier 156 is denoted as VC. An inverting input of the comparator 157 is configured to receive a low-side current sense signal VCS proportional to the current flowing through the low-side switch Q2. The output of the comparator 157 is fed into the PWM generator 154. The output signal of the comparator 157 is denoted as COMP (a comparison output signal).

The PWM generator 154 is able to determine the turn-on time instant of Q1 based on the COMP signal and a clock signal CLK. In addition, the PWM generator 154 determines the on-time duration based on the desired output voltage and other circuit operating parameters. The on-time duration remains constant for a given set of conditions.

In operation, the error amplifier 156 is configured to generate VC based on VREF and FB signals. The comparator 157 compares VC with the low-side current sense signal VCS. When the low-side current sense signal VCS drops below VC, the comparator 157 generates a COMP pulse. The COMP pulse functions as a set signal for determining a turn-on time instant of the high-side switch Q1 of the power converter. In response to the COMP pulse sent from the comparator 157, the high-side switch Q1 is turned on. An on-timer inside the PWM generator 154 is started simultaneously with the turn-on of Q1. The on-timer runs for a pre-set on-time duration. Once the on-timer reaches the end of the pre-set on-time duration, the on-timer is configured to produce a reset signal for determining a turn-off time instant of Q1. In response to the reset signal, the high-side switch Q1 is turned off. In other words, the output (PWM) of the PWM generator 154 determines both the turn-on and turn-off time instants of the high-side switch Q1.

As shown in FIG. 1, the output of the PWM generator 154 is fed into the control logic block 150. The control logic block 150 is employed to generate a high-side gate drive signal HSON and a low-side gate drive signal LSON based upon the PWM signal generated by the PWM generator 154. Furthermore, depending on different applications and design needs, the control logic block 150 adds a suitable delay between the high-side gate drive signal HSON and the low-side gate drive signal LSON. As shown in FIG. 1, the high-side gate drive signal HSON is applied to the gate of Q1. The low-side gate drive signal LSON is applied to the gate of Q2.

As shown in FIG. 1, the PWM generator 154 is configured to receive the clock signal CLK. The PWM generator 154 is able to achieve frequency synchronization through a phase-locked loop circuit. More particularly, a rising edge of the clock signal may precede or follow a rising edge of the PWM signal. The phase-locked loop circuit in the PWM generator 154 is able to adjust the leading edge of the PWM signal so that the leading edge of the PWM signal is aligned with the leading edge of the clock signal CLK.

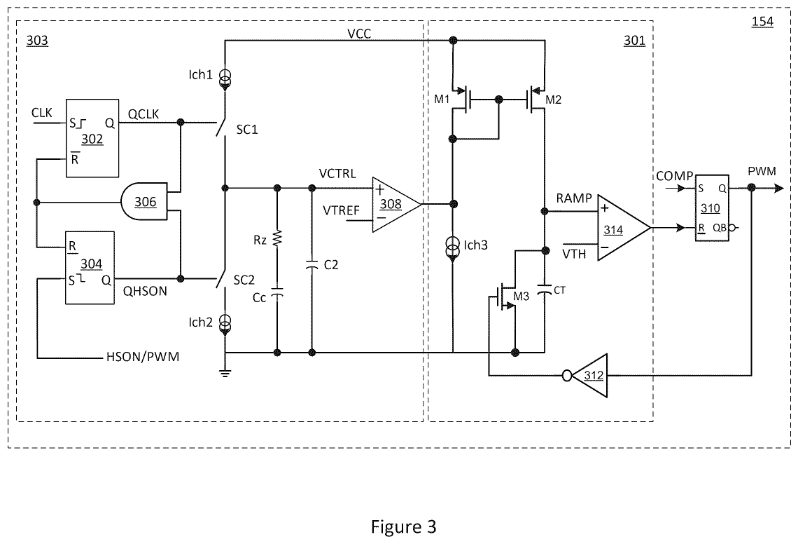

The PWM generator 154 comprises a phase-locked loop circuit, an on-timer and a latch. The on-timer comprises a ramp generator formed by a ramp capacitor and a current source configured to charge the ramp capacitor. The phase-locked loop circuit is able to adjust the current flowing through the current source once over a plurality of predetermined switching periods to synchronize the PWM signal of the power converter with the clock signal CLK. In particular, the current of the ramp generator is increased when a rising edge of the clock signal CLK precedes a rising edge of the PWM signal. On the other hand, the current of the ramp generator is decreased when the leading edge of the PWM signal precedes the leading edge of the clock signal. The detailed structure and operating principle of the PWM generator 154 will be described below with respect to FIGS. 3-7.

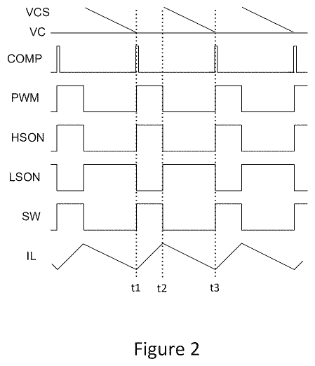

FIG. 2 illustrates a timing diagram of various signals associated with the constant on-time power converter shown in FIG. 1 in accordance with various embodiments of the present disclosure. The timing diagram has seven rows. The first row represents the low-side current sense signal VCS and the output signal VC of the error amplifier 156. The second row represents the output (COMP) of the comparator 157. The third row represents the voltage on the output signal PWM of the PWM generator 154. The fourth row represents the high-side gate drive signal HSON. The fifth row represents the low-side gate drive signal LSON. The sixth row represents the voltage on the switching node SW. The seventh row represents the current flowing through the inductor L1.

It should be noted that, as shown in FIG. 2, the PWM signal and the high-side gate drive signal HSON are identical. Throughout the description, these two signals are used interchangeably.

As shown in FIG. 2, at t1, the low-side current sense signal VCS drops below VC. The comparator 157 generates a pulse (COMP). In response to this pulse, PWM changes from a logic low state to a logic high state. PWM is fed into the control logic block 150 in which the logic high state of PWM is converted into a gate drive signal to turn on Q1. Once Q1 is turned on, the voltage on the switching node SW is equal to VIN. From t1 to t2, Q1 remains on, and the current flowing through the inductor L1 ramps up in a linear manner as shown in FIG. 2. At t2, the on-timer in the PWM generator 154 reaches the end of the pre-set on-time duration. The on-timer generates a reset signal to terminate the turn-on pulse of Q1. Accordingly, PWM changes from a logic high state to a logic low state. In response to this logic low state, Q1 is turned off and Q2 is turned on at t2. Once Q2 is turned on, the voltage on the switching node SW is equal to the ground potential. From t2 to t3, Q2 remains on, and the current flowing through the inductor L1 ramps down in a linear manner as shown in FIG. 2.

FIG. 3 illustrates a schematic diagram of the PWM generator shown in FIG. 1 in accordance with various embodiments of the present disclosure. The PWM generator 154 comprises an on-timer 301, a phase-locked loop circuit 303 and a latch 310. The on-timer 301 comprises a ramp generator and an on-time generation comparator 314.

As shown in FIG. 3, the phase-locked loop circuit 303 comprises a first latch 302, a second latch 304, a logic gate 306, a first current source Ich1, a second current source Ich2, a first control switch SC1, a second control switch SC2, a resistor Rz, a first capacitor Cc, a second capacitor C2 and an amplifier 308. In some embodiments, the amplifier 308 is a transconductance amplifier configured to produce a current signal proportional to an input voltage. The logic gate 306 is an AND gate.

As shown in FIG. 3, a set input of the first latch 302 is configured to receive the clock signal CLK. A reset input of the first latch 302 is configured to receive an output signal of the logic gate 306. A set input of the second latch 304 is configured to receive the PWM signal. A reset input of the second latch 304 is configured to receive the output signal of the logic gate 306. A first input of the logic gate 306 is configured to receive an output signal of the first latch 302. A second input of the logic gate 306 is configured to receive an output signal of the second latch 304. The first current source Ich1, the first control switch SC1, the second control switch SC2 and the second current source Ich2 are connected in series between a bias voltage bus VCC of the power converter and ground. A gate of the first control switch SC1 is controlled by the output signal (QCLK) of the first latch 302. A gate of the second control switch SC2 is controlled by the output signal (QHSON) of the second latch 304. The resistor Rz and the first capacitor Cc are connected in series between a common node of the first control switch SC1 and the second control switch SC2, and ground. The second capacitor C2 is connected between the common node of the first control switch SC1 and the second control switch SC2, and ground. A non-inverting input of the amplifier 308 is connected to the common node of the first control switch SC1 and the second control switch SC2. An inverting input of the amplifier 308 is configured to receive a reference signal VTREF.

As shown in FIG. 3, the ramp generator comprises a ramp generation current mirror comprising a first ramp transistor M1 and a second ramp transistor M2, a ramp generation current source Ich3, a ramp capacitor CT, a third ramp transistor M3 and a ramp inverter 312.

As shown in FIG. 3, a gate of the first ramp transistor M1 is connected to a gate of the second ramp transistor M2. The first ramp transistor M1 and the ramp generation current source Ich3 are connected in series between the bias voltage bus VCC of the power converter and ground. A common node of the ramp generation current source Ich3 and the first ramp transistor M1 is connected to the gate of the first ramp transistor M1. The common node of the ramp generation current source Ich3 and the first ramp transistor M1 is also connected to the output of the amplifier 308. The second ramp transistor M2 and the ramp capacitor CT are connected in series between the bias voltage bus VCC of the power converter and ground. As shown in FIG. 3, a ramp signal RAMP is generated at a common node of the second ramp transistor M2 and the ramp capacitor CT. The third ramp transistor M3 is connected in parallel with the ramp capacitor CT. A gate of the third ramp transistor M3 is configured to receive the PWM signal through the ramp inverter 312.

The on-time generation comparator 314 has a non-inverting input configured to receive the ramp signal RAMP, an inverting input configured to receive a predetermined on-time generation threshold VTH and an output configured to generate the reset signal. A set input of the latch 310 is configured to receive the COMP signal generated by the comparator 157 shown in FIG. 1. A reset input of the latch 310 is configured to receive the reset signal generated by the on-time generation comparator 314.

In operation, the PWM generator 154 synchronizes the PWM signal of the power converter with the clock signal CLK by adjusting the charging current flowing into CT. This adjustment ensures that the operating frequency of the power converter matches the frequency of the clock signal CLK. In operation, when the PWM generator 154 detects that the PWM signal is out of phase with the clock signal CLK, it adjusts voltage on VCTRL, either increasing or decreasing the PWM period to bring the PWM signal and the clock signal CLK into closer alignment.

In operation, when the rising edge of the clock signal CLK occurs before the rising edge of the PWM signal, the QCLK signal goes high and remains high until the rising edge of the PWM signal arrives. During this period, while QCLK is high, the first control switch SC1 is turned on, increasing the charging current flowing into the second capacitor C2 and causing the voltage on VCTRL to rise. The amplifier 308 monitors this rise and compares it with the reference voltage VTREF. Through the transconductance amplifier 308, the increased voltage on VCTRL relative to VTREF results in an increase in the current flowing through the third current source Ich3, which in turn increases the current flowing into the ramp capacitor CT. As the current flowing into CT increases, the voltage across CT rises more quickly. This rapid increase in voltage triggers the on-time generation comparator 314 sooner, which resets the latch 310. Resetting the latch 310 turns off Q1 earlier, thus shortening the PWM period for the power converter. This results in the next rising edge of the PWM signal occurring earlier, aligning the PWM signal more closely with the clock signal CLK.

Conversely, if the rising edge of the PWM signal occurs before the rising edge of CLK, the QHSON signal goes high and remains high until the rising edge of CLK arrives. During this period, while QHSON is high, the second control switch SC2 is turned on, reducing the voltage on VCTRL. The amplifier 308 monitors the reduced voltage on VCTRL, and compares it with the reference voltage VTREF. Through the transconductance amplifier 308, the reduced voltage on VCTRL relative to VTREF results in a decrease in the current flowing through the third current source Ich3, which in turn slow down the charging rate of the ramp capacitor CT. The slower charging rate causes the on-time generation comparator 314 to take longer to output a high signal, keeping the high-side switch Q1 on for a longer duration, thereby extending the PWM period and delaying the next rising edge of PWM. This delay adjusts the timing so that the rising edge of PWM aligns more closely with the rising edge of CLK, helping to synchronize these two signals effectively. This continuous adjustment of the PWM period ensures that the switching frequency of the power converter remains in sync with the frequency of the clock signal CLK.

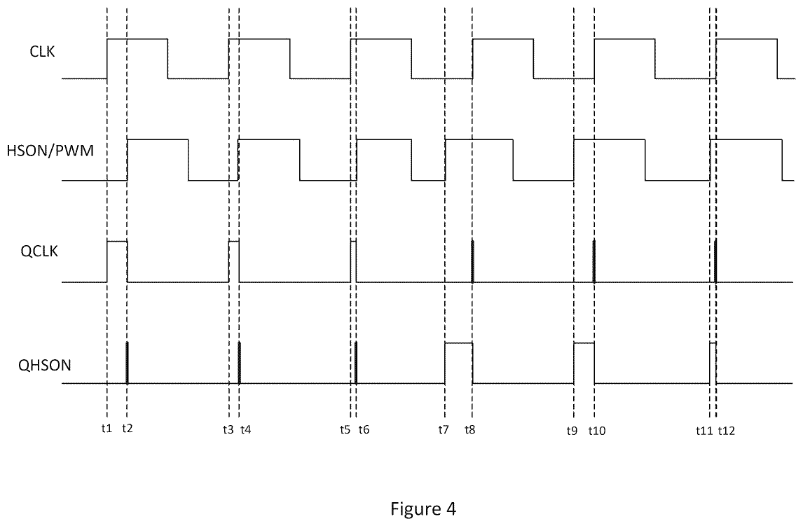

FIG. 4 illustrates a timing diagram of various signals associated with a first control implementation of the phase-locked loop circuit shown in FIG. 3 in accordance with various embodiments of the present disclosure. The horizontal axis of FIG. 4 represents intervals of time. There are four rows in FIG. 4. The first row represents the clock signal CLK shown in FIG. 3. The second row represents the high-side gate drive signal HSON and the PWM signal. The third row represents the QCLK signal shown in FIG. 3. The fourth row represents the QHSON signal shown in FIG. 3.

Referring back to FIG. 3, in operation, when a rising edge of the clock signal CLK occurs, the latch 302 output QCLK is set to a logic high state (“1”). When a rising edge of the high-side gate drive signal HSON occurs, the latch 304 output QHSON is set to a logic high state (“1”). When both QCLK and QHSON are set to a logic high state, both the latch 302 and the latch 304 are reset to a logic low state (“0”).

As shown in FIG. 4, at t1, the rising edge of CLK occurs earlier than the rising edge of HSON. In response to this, QCLK goes high and remain high until the rising edge of HSON arrives at t2. Referring back to FIG. 3, when QCLK is high, it turns on the first control switch SC1. The turn-on of SC1 enables the first current source Ich1 to charge the capacitor C2. As a result, the voltage on VCTRL increases. Through the transconductance amplifier 308, the increased voltage on VCTRL relative to VTREF results in an increased current flowing through the third current source Ich3. Through the current mirror formed by M1 and M2, the charging current flowing into CT increases, thereby reducing the cycle period of the power converter. The reduction in cycle period shifts the rising edge of HSON closer to the rising edge of CLK. As shown in FIG. 4, over three clock periods, the period of the PWM signal is gradually shortened by increasing the charging current of CT, causing the rising edge of HSON to shift earlier. The gap between the rising edges of CLK and HSON decreases progressively. As shown in FIG. 4, the gap from t1 to t2 in the first clock period is larger than the gap from t3 to t4 in the second clock period. The gap from t3 to t4 in the second clock period is larger than the gap from t5 to t6 in the third clock period. Eventually, the rising edge of HSON is aligned with the rising edge of CLK, achieving synchronization.

As shown in FIG. 4, at t7, the rising edge of HSON occurs earlier than the rising edge of CLK. In response to this, QHSON goes high and remain high until the rising edge of CLK arrives at t8. Referring back to FIG. 3, when QHSON is high, it turns on the second control switch SC2. The turn-on of SC2 enables the second current source Ich2 to discharge the capacitor C2. As a result, the voltage on VCTRL decreases. Through the transconductance amplifier 308, the decreased voltage on VCTRL relative to VTREF results in a decreased current flowing through the third current source Ich3. Through the current mirror formed by M1 and M2, the charging current flowing into CT decreases, thereby extending the PWM period of the power converter. The increase in PWM period shifts the rising edge of HSON closer to the rising edge of CLK. As shown in FIG. 4, over three clock periods, the PWM period is gradually increased by reducing the charging current of CT, causing the rising edge of HSON to shift later. The gap between the rising edges of CLK and HSON decreases progressively. As shown in FIG. 4, the gap from t7 to t8 in the fourth clock period is larger than the gap from t9 to t10 in the fifth clock period. The gap from t9 to t10 in the fifth clock period is larger than the gap from t11 to t12 in the sixth clock period. Eventually, the rising edge of HSON is aligned with the rising edge of CLK, achieving synchronization.

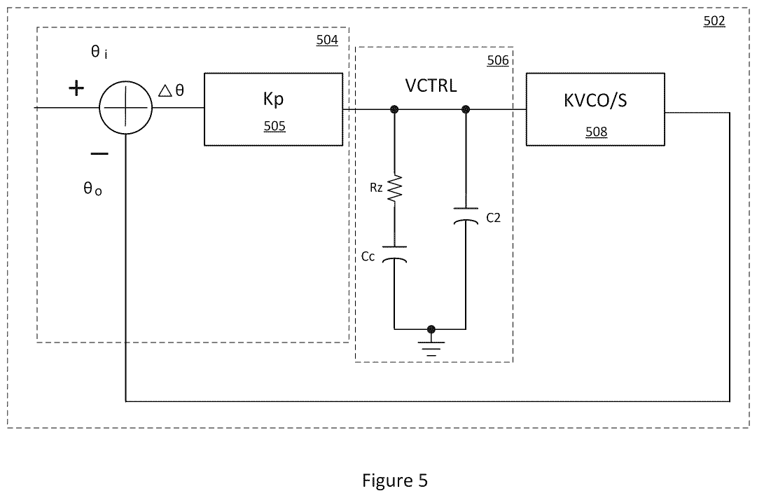

FIG. 5 illustrates a small signal model of the phase-locked loop circuit shown in FIG. 3 in accordance with various embodiments of the present disclosure. The small signal model of a phase-locked loop circuit is typically represented as a control system comprising a phase detector 504, a loop filter 506, a voltage-controlled oscillator 508 and a feedback path as shown in FIG. 5. The loop filter 506 comprises a resistor Rz, a first capacitor Cc and a second capacitor C2.

In operation, the phase detector 504 compares the phase of a reference signal Oi with the phase of the output signal Oo to produce a phase error signal 40 by taking their difference. This phase error signal AO is then processed by a gain stage 505 within the phase detector 504 to generate a proportional control signal. The loop filter 506 processes the proportional control signal to obtain the control volage VCTRL. The control voltage VCTRL drives the voltage-controlled oscillator 508. The voltage-controlled oscillator 508 converts the control voltage VCTRL into an output frequency and integrates it into the phase of the output signal Oo. Through the feedback path, the phase of the output signal Oo is fed back to the phase detector 504 for comparison.

The transfer function of the small signal model shown in FIG. 5 can be expressed by the following equation:

$$H ( S ) = {K}_{p} \frac{1 + {SR}_{Z} {C}_{C}}{S ( {C}_{C} + {C}_{2} ) ( I + S \frac{{C}_{C} {C}_{2}}{{C}_{C} + {C}_{2}} {R}_{Z} )} \times KVCO \times \frac{1}{s} \qquad ( 1 )$$

In Equation (1), Kp is the phase detector gain. Kp is equal to Ich/2π. Ich represents the amount of charge injected into the phase detector 504 when there is a phase difference between the input signals. KVCO is the gain of the voltage-controlled oscillator 508.

In Equation (1), there are three poles and one zero. A first pole and a second pole are at the origin. A third pole can be expressed as:

$${w}_{p} = \frac{1}{{R}_{Z} {C}_{2}} \qquad ( 2 )$$

The zero can be expressed as:

$${w}_{Z} = \frac{1}{{R}_{Z} {C}_{c}} \qquad ( 3 )$$

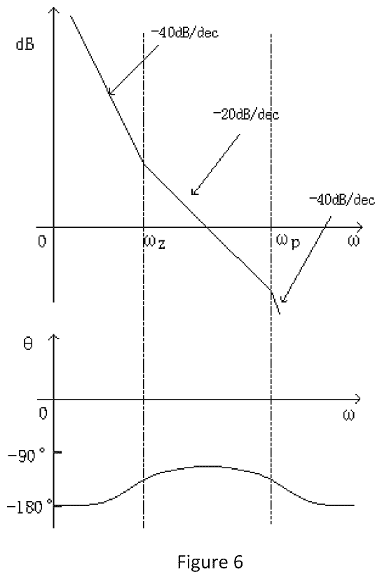

The location of Wp and the location of Wz are shown in a Bode plot to be discussed below with respect to FIG. 6.

FIG. 6 illustrates a Bode plot of the phase-locked loop circuit shown in FIG. 3 in accordance with various embodiments of the present disclosure. The Bode plot include a magnitude plot and a phase plot. The magnitude plot in an upper portion of FIG. 6 shows how the gain of the phase-locked loop circuit varies with frequency. The phase plot in a lower portion of FIG. 6 shows how the phase of the output signal lags or leads the input signal as a function of frequency.

Due to the presence of the first and second poles at the origin, the phase-locked loop circuit already has a 180° phase shift at low frequencies. If the 0 dB crossover point lies between Wz and Wp, a phase margin greater than 45° can theoretically be achieved. At this point, the system bandwidth can be approximately calculated as:

$$0 dB = 1 = {K}_{p} \frac{{R}_{Z} {C}_{C}}{( {C}_{C} + {C}_{2} )} \times KVCO \times \frac{1}{2 π * {f}_{BW}} \qquad ( 4 )$$

From Equation (4), assuming Cc is greater than C2, the bandwidth of the phase-locked loop circuit can be expressed as:

$${f}_{BW} = \frac{{I}_{ch}}{2 π} \times {R}_{Z} \times KVCO \times \frac{1}{2 π} \qquad ( 5 )$$

Equation (5) indicates that the bandwidth of the phase-locked loop circuit is proportional to Ich and Rz. To ensure that the 0 dB crossover point lies between Wz and Wp, the bandwidth of the phase-locked loop circuit must satisfy the following conditions:

$${f}_{B W} > \frac{1}{2 π} \times \frac{1}{{R}_{Z} {C}_{C}} \qquad ( 6 )$$

$$\frac{{I}_{ch}}{2 π} \times {R}_{Z} \times KVCO > \frac{1}{{R}_{Z} {C}_{C}} \qquad ( 7 )$$

In a step-down power converter (e.g., the power converter shown in FIG. 1), the bandwidth of the phase-locked loop circuit is typically designed to be lower than the bandwidth of the step-down power converter to ensure loop stability. When the frequency of the clock signal CLK decreases, the bandwidth of the step-down power converter also decreases, requiring the Wz and Wp frequencies of the phase-locked loop circuit to be correspondingly lower. This necessitates the use of a larger filter capacitor, which consumes significant layout area. If the filter capacitor is too small, its ability to suppress voltage ripple at the output becomes inadequate. This results in excessive gain at the ripple frequency, causing the loop of the phase-locked loop circuit to oscillate during stabilization. As a result, the phase-locked loop circuit may fail to lock onto a single frequency and instead switch between two frequencies.

To reduce voltage ripple at the filter output, Rz can be lowered or Ich can be reduced. However, reducing Rz shifts the zero of the phase-locked loop circuit to a higher frequency while decreasing the loop bandwidth. This could cause the bandwidth to fall below the zero frequency, preventing proper phase correction and leading to stability issues. On the other hand, decreasing Ich does not affect the zero frequency, but if Ich is too small, effective charge and discharge pulses to the filter cannot be obtained. This can cause the loop of the phase-locked loop circuit to open, resulting in a system failure. Therefore, the present disclosure proposes a multi-cycle sampling method, in which a single charge/discharge pulse is generated over multiple clock cycles while maintaining Ich constant. For example, the CLK and PWM signals are checked once every three clock cycles, generating a QCLK or QHSON signal to charge or discharge the filter formed by Rz, Cc and C2. This multi-cycle sampling method averages the ripple voltage caused by a single charge/discharge pulse over multiple cycles, effectively reducing Ich. This lowers the loop bandwidth of the phase-locked loop circuit, allowing the system to maintain sufficient stability margin.

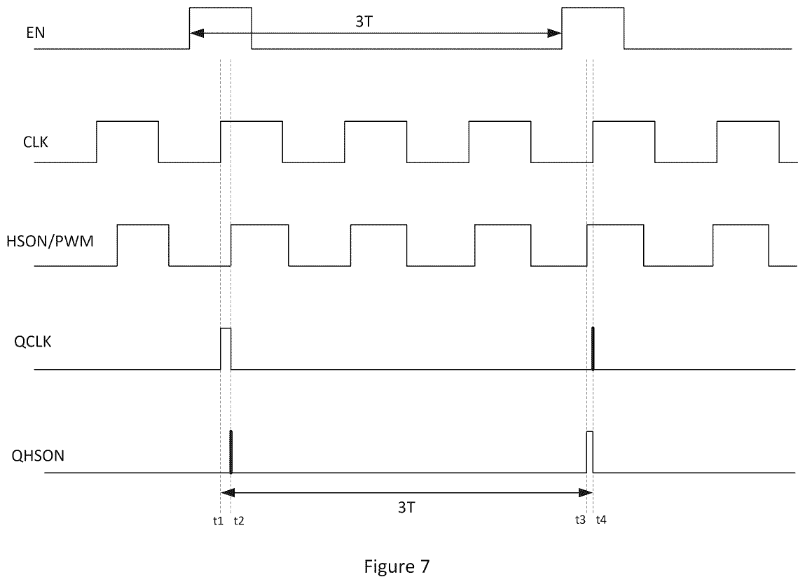

FIG. 7 illustrates a timing diagram of various signals associated with a second control implementation of the phase-locked loop circuit shown in FIG. 3 in accordance with various embodiments of the present disclosure. The horizontal axis of FIG. 7 represents intervals of time. There are five rows in FIG. 7. The first row represents an enable signal EN. The second row represents the clock signal CLK shown in FIG. 3. The third row represents the high-side gate drive signal HSON and the PWM signal. The fourth row represents the QCLK signal shown in FIG. 3. The fifth row represents the QHSON signal shown in FIG. 3.

The timing diagram shown in FIG. 7 is similar to the timing diagram shown in FIG. 4 except that the current of the ramp generator is adjusted only once over a plurality of predetermined clock periods to synchronize the PWM signal of the power converter with the clock signal CLK. In some embodiments, as shown in FIG. 7, the current of the ramp generator is adjusted only once over three clock periods (3T) to synchronize the PWM signal of the power converter with the clock signal CLK. This control scheme is alternatively referred to as a multi-cycle sampling method. The enable signal EN is employed to allow the CLK and PWM signals to be checked once every three clock periods (3T). For example, as shown in FIG. 7, from t1 to t2, the phase-locked loop circuit is enabled to adjust the current flowing into the ramp capacitor so as to synchronize the PWM signal of the power converter with the clock signal CLK. After t2, the phase-locked loop circuit is disabled for three clock periods. From t3 to t4, the phase-locked loop circuit is enabled again to adjust the current flowing into the ramp capacitor, maintaining synchronization between the PWM signal and the clock signal CLK.

One advantageous feature of the multi-cycle sampling method shown in FIG. 7 is that the equivalent filtering effect of the filter capacitor is improved, making the loop more likely to stabilize at a single frequency.

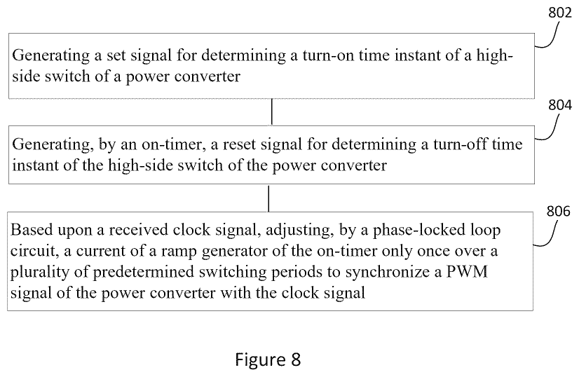

FIG. 8 illustrates a flow chart of a method for controlling the constant on-time power converter shown in FIG. 1 in accordance with various embodiments of the present disclosure. This flowchart shown in FIG. 8 is merely an example, which should not unduly limit the scope of the claims. One of ordinary skill in the art would recognize many variations, alternatives, and modifications. For example, various steps illustrated in FIG. 8 may be added, removed, replaced, rearranged and repeated.

Referring back to FIG. 1, a power converter is connected between an input power source and a load. The power converter is a constant on-time power converter. The control circuit of the power converter comprises a comparator, a PWM generator, a control logic block and a voltage divider.

At step 802, a set signal for determining a turn-on time instant of a high-side switch of a power converter is generated.

At step 804, by an on-timer, a reset signal for determining a turn-off time instant of the high-side switch of the power converter is generated.

At step 806, based upon a received clock signal, by a phase-locked loop circuit, a current of a ramp generator of the on-timer is adjusted only once over a plurality of predetermined switching periods to synchronize a PWM signal of the power converter with the clock signal.

The method further comprises generating the set signal using an error amplifier and a comparator, wherein the error amplifier has an inverting input configured to receive a feedback signal, a non-inverting input configured to receive a predetermined reference and an output configured to generate a control signal, and the comparator has an inverting input configured to receive a current sense signal proportional to a current flowing through a low-side switch of the power converter, a non-inverting input configured to receive the control signal and an output configured to generate the set signal.

The method further comprises increasing the current of the ramp generator when a leading edge of the clock signal precedes a leading edge of the PWM signal, and decreasing the current of the ramp generator when the leading edge of the PWM signal precedes the leading edge of the clock signal.

In some embodiments, the phase-locked loop circuit is configured to adjust the current of the ramp generator only once over three switching periods to synchronize the PWM signal of the power converter with the clock signal.

In some embodiments, the on-timer comprises the ramp generator and an on-time generation comparator. The ramp generator comprises a ramp generation current mirror comprising a first ramp transistor and a second ramp transistor, and wherein a gate of the first ramp transistor is connected to a gate of the second ramp transistor, a ramp generation current source connected in series with the first ramp transistor between a bias voltage bus of the power converter and ground, and wherein a common node of the ramp generation current source and the first ramp transistor is connected to the gate of the first ramp transistor, a ramp capacitor, and wherein the second ramp transistor and the ramp capacitor are connected in series between the bias voltage bus of the power converter and ground, and wherein a ramp signal is generated at a common node of the second ramp transistor and the ramp capacitor, and a third ramp transistor connected in parallel with the ramp capacitor, and wherein a gate of the third ramp transistor is configured to receive the PWM signal through a ramp inverter. The on-time generation comparator has a non-inverting input configured to receive the ramp signal, an inverting input configured to receive a predetermined on-time generation threshold and an output configured to generate the reset signal. The phase-locked loop circuit comprises a first latch, a second latch, a logic gate, a first current source, a second current source, a first control switch, a second control switch, a resistor, a first capacitor, a second capacitor and an amplifier. A set input of the first latch is configured to receive the clock signal, a reset input of the first latch is configured to receive an output signal of the logic gate, a set input of the second latch is configured to receive the PWM signal, a reset input of the second latch is configured to receive the output signal of the logic gate, a first input of the logic gate is configured to receive an output signal of the first latch, a second input of the logic gate is configured to receive an output signal of the second latch, the first current source, the first control switch, the second control switch and the second current source are connected in series between the bias voltage bus of the power converter and ground, and wherein a gate of the first control switch is controlled by the output signal of the first latch, and a gate of the second control switch is controlled by the output signal of the second latch, the resistor and the first capacitor are connected in series between a common node of the first control switch and the second control switch, and ground, the second capacitor is connected between the common node of the first control switch and the second control switch, and ground, a non-inverting input of the amplifier is connected to the common node of the first control switch and the second control switch, and an inverting input of the amplifier is configured to receive a reference signal.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. An apparatus comprising:
an on-timer configured to produce a reset signal for determining a turn-off time instant of a high-side switch of a power converter, wherein the on-timer comprises a ramp generator;
a feedback control circuit configured to produce a set signal for determining a turn-on time instant of the high-side switch of the power converter; and
a phase-locked loop circuit configured to receive a clock signal and adjust a current of the ramp generator only once over a plurality of predetermined switching periods to synchronize a pulse width modulation (PWM) signal of the power converter with the clock signal.

2. The apparatus of claim 1, wherein:
the power converter is a constant on-time power converter configured to be connected between a power source and a load.

3. The apparatus of claim 1, wherein:
the feedback control circuit comprises an error amplifier and a comparator, and wherein:
the error amplifier has an inverting input configured to receive a feedback signal, a non-inverting input configured to receive a predetermined reference and an output configured to generate a control signal; and
the comparator has an inverting input configured to receive a current sense signal proportional to a current flowing through a low-side switch of the power converter, a non-inverting input configured to receive the control signal and an output configured to generate the set signal.

4. The apparatus of claim 1, further comprising:
a latch configured to receive the set signal generated by the feedback control circuit and the reset signal generated by the on-timer, and generate the PWM signal, wherein:
the ramp generator is configured to generate a ramp signal, and wherein the reset signal is generated once the ramp signal exceeds a predetermined voltage threshold; and
the PWM signal is fed into a control logic block, and wherein based on the PWM signal, the control logic block is configured to generate a high-side gate drive signal and a low-side gate drive signal for driving the high-side switch and a low-side switch of the power converter, respectively.

5. The apparatus of claim 4, wherein a PWM generator comprises the phase-locked loop circuit, the on-timer comprising the ramp generator and an on-time generation comparator, and the latch, and wherein:
the ramp generator comprises:
a ramp generation current mirror comprising a first ramp transistor and a second ramp transistor, and wherein a gate of the first ramp transistor is connected to a gate of the second ramp transistor;
a ramp generation current source connected in series with the first ramp transistor between a bias voltage bus of the power converter and ground, and wherein a common node of the ramp generation current source and the first ramp transistor is connected to the gate of the first ramp transistor;
a ramp capacitor, and wherein the second ramp transistor and the ramp capacitor are connected in series between the bias voltage bus of the power converter and ground, and wherein the ramp signal is generated at a common node of the second ramp transistor and the ramp capacitor; and
a third ramp transistor connected in parallel with the ramp capacitor, and wherein a gate of the third ramp transistor is configured to receive the PWM signal through a ramp inverter; and
the on-time generation comparator comprises a non-inverting input configured to receive the ramp signal, an inverting input configured to receive a predetermined on-time generation threshold and an output configured to generate the reset signal.

6. The apparatus of claim 5, wherein:
the phase-locked loop circuit comprises a first latch, a second latch, a logic gate, a first current source, a second current source, a first control switch, a second control switch, a resistor, a first capacitor, a second capacitor and an amplifier, and wherein the phase-locked loop circuit is configured such that:
the current of the ramp generator is increased when a leading edge of the clock signal precedes a leading edge of the PWM signal; and
the current of the ramp generator is decreased when the leading edge of the PWM signal precedes the leading edge of the clock signal.

7. The apparatus of claim 6, wherein:
a set input of the first latch is configured to receive the clock signal;
a reset input of the first latch is configured to receive an output signal of the logic gate;
a set input of the second latch is configured to receive the PWM signal;
a reset input of the second latch is configured to receive the output signal of the logic gate;
a first input of the logic gate is configured to receive an output signal of the first latch;
a second input of the logic gate is configured to receive an output signal of the second latch;
the first current source, the first control switch, the second control switch and the second current source are connected in series between the bias voltage bus of the power converter and ground, and wherein a gate of the first control switch is controlled by the output signal of the first latch, and a gate of the second control switch is controlled by the output signal of the second latch;
the resistor and the first capacitor are connected in series between a common node of the first control switch and the second control switch, and ground;
the second capacitor is connected between the common node of the first control switch and the second control switch, and ground;
a non-inverting input of the amplifier is connected to the common node of the first control switch and the second control switch; and
an inverting input of the amplifier is configured to receive a reference signal.

8. The apparatus of claim 7, wherein:
the amplifier is a transconductance amplifier configured to produce a current signal proportional to an input voltage, and wherein the current signal is configured to adjust the current of the ramp generator; and
the logic gate is an AND gate.

9. The apparatus of claim 1, wherein:
the phase-locked loop circuit is configured to adjust the current of the ramp generator only once over three switching periods of the clock signal to synchronize the PWM signal of the power converter with the clock signal.

10. The apparatus of claim 1, wherein:
the power converter comprises the high-side switch, a low-side switch, and an inductor, and wherein:
the high-side switch and the low-side switch are connected in series between an input voltage bus and ground; and
the inductor is connected between a common node of the high-side switch and the low-side switch, and an output terminal of the power converter.

11. A method comprising:
generating a set signal for determining a turn-on time instant of a high-side switch of a power converter;
generating, by an on-timer, a reset signal for determining a turn-off time instant of the high-side switch of the power converter; and
based upon a received clock signal, adjusting, by a phase-locked loop circuit, a current of a ramp generator of the on-timer only once over a plurality of predetermined switching periods to synchronize a PWM signal of the power converter with the clock signal.

12. The method of claim 11, further comprising:
generating the set signal using an error amplifier and a comparator, wherein:
the error amplifier has an inverting input configured to receive a feedback signal, a non-inverting input configured to receive a predetermined reference and an output configured to generate a control signal; and
the comparator has an inverting input configured to receive a current sense signal proportional to a current flowing through a low-side switch of the power converter, a non-inverting input configured to receive the control signal and an output configured to generate the set signal.

13. The method of claim 11, further comprising:
increasing the current of the ramp generator when a leading edge of the clock signal precedes a leading edge of the PWM signal; and
decreasing the current of the ramp generator when the leading edge of the PWM signal precedes the leading edge of the clock signal.

14. The method of claim 11, wherein:
the phase-locked loop circuit is configured to adjust the current of the ramp generator only once over three switching periods to synchronize the PWM signal of the power converter with the clock signal.

15. The method of claim 11, wherein:
the on-timer comprises the ramp generator and an on-time generation comparator, and wherein:
the ramp generator comprises:
a ramp generation current mirror comprising a first ramp transistor and a second ramp transistor, and wherein a gate of the first ramp transistor is connected to a gate of the second ramp transistor;
a ramp generation current source connected in series with the first ramp transistor between a bias voltage bus of the power converter and ground, and wherein a common node of the ramp generation current source and the first ramp transistor is connected to the gate of the first ramp transistor;
a ramp capacitor, and wherein the second ramp transistor and the ramp capacitor are connected in series between the bias voltage bus of the power converter and ground, and wherein a ramp signal is generated at a common node of the second ramp transistor and the ramp capacitor; and
a third ramp transistor connected in parallel with the ramp capacitor, and wherein a gate of the third ramp transistor is configured to receive the PWM signal through a ramp inverter;
the on-time generation comparator has a non-inverting input configured to receive the ramp signal, an inverting input configured to receive a predetermined on-time generation threshold and an output configured to generate the reset signal; and
the phase-locked loop circuit comprises a first latch, a second latch, a logic gate, a first current source, a second current source, a first control switch, a second control switch, a resistor, a first capacitor, a second capacitor and an amplifier, and wherein:
a set input of the first latch is configured to receive the clock signal;
a reset input of the first latch is configured to receive an output signal of the logic gate;
a set input of the second latch is configured to receive the PWM signal;
a reset input of the second latch is configured to receive the output signal of the logic gate;
a first input of the logic gate is configured to receive an output signal of the first latch;
a second input of the logic gate is configured to receive an output signal of the second latch;
the first current source, the first control switch, the second control switch and the second current source are connected in series between the bias voltage bus of the power converter and ground, and wherein a gate of the first control switch is controlled by the output signal of the first latch, and a gate of the second control switch is controlled by the output signal of the second latch;
the resistor and the first capacitor are connected in series between a common node of the first control switch and the second control switch, and ground;
the second capacitor is connected between the common node of the first control switch and the second control switch, and ground;
a non-inverting input of the amplifier is connected to the common node of the first control switch and the second control switch; and
an inverting input of the amplifier is configured to receive a reference signal.

16. A power converter comprising:
a power stage comprising a high-side switch and a low-side switch connected in series between an input voltage bus and ground;
an inductor connected between a common node of the high-side switch and the low-side switch, and an output terminal of the power converter; and
a control apparatus comprising:
an on-timer configured to produce a reset signal for determining a turn-off time instant of the high-side switch of a power converter, wherein the on-timer comprises a ramp generator;
a feedback control circuit configured to produce a set signal for determining a turn-on time instant of the high-side switch of the power converter; and
a phase-locked loop circuit configured to receive a clock signal and adjust a current of the ramp generator only once over a plurality of predetermined switching periods to synchronize a PWM signal of the power converter with the clock signal.

17. The power converter of claim 16, further comprising:
a control logic circuit configured to receive the PWM signal, and generate a high-side gate drive signal and a low-side gate drive signal for the high-side switch and the low-side switch, respectively.

18. The power converter of claim 16, wherein:
the feedback circuit comprises a resistor divider, an error amplifier and a comparator, and wherein:
the resistor divider is connected between the output terminal of the power converter and ground;
the error amplifier has an inverting input configured to receive a feedback signal tapped from a midpoint of the resistor divider, a non-inverting input configured to receive a predetermined reference and an output configured to generate a control signal; and
the comparator has an inverting input configured to receive a current sense signal proportional to a current flowing through the low-side switch, a non-inverting input configured to receive the control signal and an output configured to generate the set signal.

19. The power converter of claim 16, wherein:
the on-timer comprises the ramp generator and an on-time generation comparator, and wherein:
the ramp generator comprises:
a ramp generation current mirror comprising a first ramp transistor and a second ramp transistor, and wherein a gate of the first ramp transistor is connected to a gate of the second ramp transistor;
a ramp generation current source connected in series with the first ramp transistor between a bias voltage bus of the power converter and ground, and wherein a common node of the ramp generation current source and the first ramp transistor is connected to the gate of the first ramp transistor;
a ramp capacitor, and wherein the second ramp transistor and the ramp capacitor are connected in series between the bias voltage bus of the power converter and ground, and wherein a ramp signal is generated at a common node of the second ramp transistor and the ramp capacitor; and
a third ramp transistor connected in parallel with the ramp capacitor, and wherein a gate of the third ramp transistor is configured to receive the PWM signal through a ramp inverter;
the on-time generation comparator has a non-inverting input configured to receive the ramp signal, an inverting input configured to receive a predetermined on-time generation threshold and an output configured to generate the reset signal; and
the phase-locked loop circuit comprises a first latch, a second latch, a logic gate, a first current source, a second current source, a first control switch, a second control switch, a resistor, a first capacitor, a second capacitor and an amplifier, and wherein:
a set input of the first latch is configured to receive the clock signal;
a reset input of the first latch is configured to receive an output signal of the logic gate;
a set input of the second latch is configured to receive the PWM signal;
a reset input of the second latch is configured to receive the output signal of the logic gate;
a first input of the logic gate is configured to receive an output signal of the first latch;
a second input of the logic gate is configured to receive an output signal of the second latch;
the first current source, the first control switch, the second control switch and the second current source are connected in series between the bias voltage bus of the power converter and ground, and wherein a gate of the first control switch is controlled by the output signal of the first latch, and a gate of the second control switch is controlled by the output signal of the second latch;
the resistor and the first capacitor are connected in series between a common node of the first control switch and the second control switch, and ground;
the second capacitor is connected between the common node of the first control switch and the second control switch, and ground;
a non-inverting input of the amplifier is connected to the common node of the first control switch and the second control switch; and
an inverting input of the amplifier is configured to receive a reference signal.

20. The power converter of claim 16, wherein:
the phase-locked loop circuit is configured to adjust the current of the ramp generator only once over three switching periods to synchronize the PWM signal of the power converter with the clock signal.
